(19) United States
(12) Patent Application Publication
(10) Pub. No.: US 2011/0222591 A1
(43) Pub. Date: Sep. 15, 2011

(54) RECEIVING CIRCUIT

(75) Inventor: Hideki FURUDATE, Kawasaki (JP)

(73) Assignee: FUJITSU LIMITED, Kawasaki (JP)

(21) Appl. No.: 13/034,440

(22) Filed: Feb. 24, 2011

(30) Foreign Application Priority Data
Mar. 12, 2010 (JP) 2010-55542

(51) Int. Cl. H04B 17/00

(52) U.S. Cl. 375/224

(57) ABSTRACT

A receiving circuit includes: an analog-to-digital converter to convert an input signal in a certain bandwidth to a digital signal; a Fourier transformer to convert the digital signal from a time-domain signal to a frequency-domain signal; a band-elimination filter to extract an interference wave signal from the time-domain signal; and a filter control circuit to measure frequency characteristics of the interference wave signal so that the attenuation characteristics of the band-elimination filter has a attenuation characteristics opposite to the frequency characteristics in a direction.

### CROSS-REFERENCE TO RELATED APPLICATIONS

This application claims the benefit of priority from Japanese Patent Application No. 2010-55542 filed on Mar. 12, 2010, the entire contents of which are incorporated herein by reference.

### BACKGROUND

1. Field

The embodiments discussed herein relate to a receiving circuit.

2. Description of Related Art

A receiving circuit detects or demodulates a received signal in a certain receiving bandwidth, or corrects errors in the received signal in the receiving bandwidth. A filter in the receiving circuit removes interference waves outside the receiving bandwidth. Upon removal of interference waves within the receiving bandwidth, the received signal may be removed.

An analog filter in the receiving circuit using an orthogonal frequency-division multiplexing (OFDM) communication method or an orthogonal frequency-division multiplexing access (OFDMA) communication method removes interference waves within a desired signal bandwidth.

The related art is disclosed in Japanese Laid-open Patent Publication No. 2000-286821, Japanese Laid-open Patent Publication No. 2000-156655, Japanese Laid-open Patent Publication No. 2000-232382, and the like.

### SUMMARY

According to one aspect of the embodiments, a receiving circuit includes: an analog-to-digital converter to convert an input signal in a certain bandwidth to a digital signal; a Fourier transformer to convert the digital signal from a time-domain signal to a frequency-domain signal; a band-elimination filter to extract an interference wave signal from the time-domain signal; and a filter control circuit to measure frequency characteristics of the interference wave signal so that the attenuation characteristics of the band-elimination filter has a attenuation characteristics opposite to the frequency characteristics in a direction.

Additional advantages and novel features of the invention will be set forth in part in the description that follows, and in part will become more apparent to those skilled in the art upon examination of the following or upon learning by practice of the invention.

### BRIEF DESCRIPTION OF THE DRAWINGS

FIG. 1 illustrates an exemplary receiving circuit;

FIG. 2 illustrates an exemplary frequency spectrum;

FIG. 3 illustrates an exemplary frequency spectrum;

FIG. 4 illustrates an exemplary frequency spectrum;

FIG. 5 illustrates an exemplary frequency spectrum;

FIG. 6 illustrates an exemplary frequency spectrum;

FIG. 7 illustrates exemplary frequency characteristics and exemplary attenuation characteristics;

FIG. 8 illustrates exemplary frequency characteristics and exemplary attenuation characteristics;

FIG. 9 illustrates exemplary frequency characteristics and exemplary attenuation characteristics;

FIG. 10 illustrates an exemplary frequency spectrum;

FIG. 11 illustrates an exemplary interference wave measuring circuit;

FIG. 12 illustrates an exemplary interference wave measuring circuit;

FIG. 13A illustrates an exemplary coefficient calculation circuit;

FIGS. 13B to 13D illustrate an exemplary frequency spectrum.

FIG. 14 illustrates an exemplary band-elimination filter;

FIG. 15 illustrates an exemplary receiving circuit;

FIG. 16 illustrates an exemplary frequency spectrum; and

FIG. 17 illustrates an exemplary receiving circuit.

### DESCRIPTION OF EMBODIMENTS

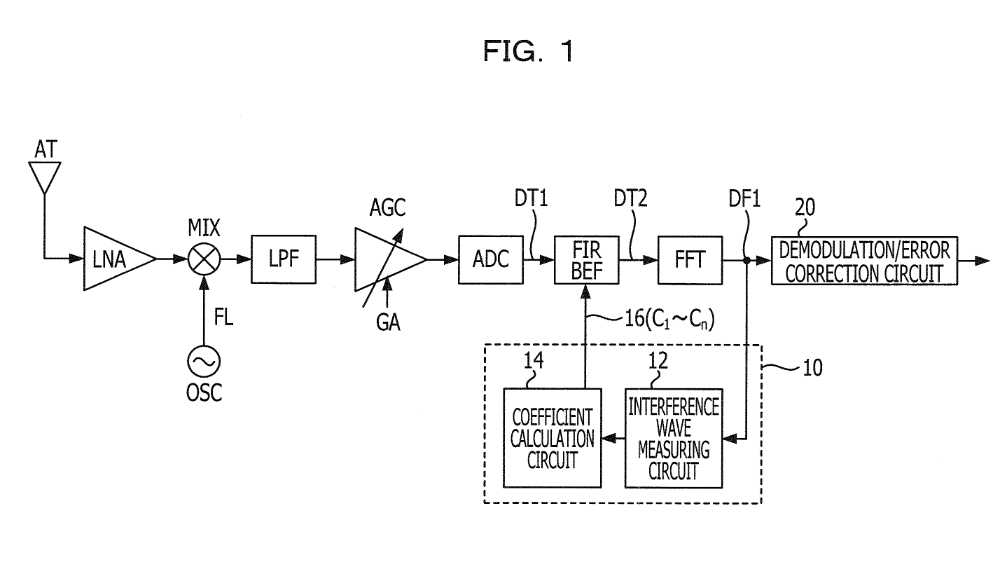

FIG. 1 illustrates an exemplary receiving circuit. The receiving circuit illustrated in FIG. 1 may use an OFDM or OFDMA communication method. A transmitter using the OFDM or OFDMA communication method modulates a plurality of subcarriers whose frequencies are in an orthogonal relationship to each other using transmission data so as to generate an OFDM frequency-domain signal, converts the OFDM frequency-domain signal to an OFDM time-domain signal through an inverse fast Fourier transform (IFFT), and up-converts the OFDM time-domain signal to a high-frequency signal for transmission. A receiver down-converts the received high-frequency signal to an OFDM time-domain signal and converts the OFDM time-domain signal to an OFDM frequency-domain signal through a fast Fourier transform (FFT) so as to demodulate the plurality of subcarriers. In the OFDMA communication method, a plurality of subcarriers may be allocated to a plurality of terminals.

The receiving circuit illustrated in FIG. 1 amplifies a signal received by an antenna AT with a low-noise amplifier LNA and extracts the received signal within a desired signal bandwidth with a mixer MIX and a low-pass filter LPF. An oscillator OSC provides the mixer MIX with a local frequency signal FL having a frequency of the desired signal. An output of the low-pass filter LPF is amplified to a desired gain by a variable gain amplifier AGC, and the amplified analog received signal is converted to a digital received signal DT1 by an analog-to-digital converter ADC. The digital received signal DT1 is a time-domain received signal including a signal in a time domain. Gain GA of the variable gain amplifier AGC may be controlled so that, for example, electric power detected by the analog-to-digital converter ADC is constant.

The receiving circuit includes a band-elimination filter BEF or a band-rejection filter that control interference waves included in the digital received signal DT1. The receiving circuit also includes a fast Fourier transformer FFT that performs a fast Fourier transform to convert a digital received signal DT2, which is an output of the band-elimination filter BEF, from a time-domain received signal to a frequency-domain received signal DF1. The frequency-domain received signal DF1 includes a plurality of subcarriers whose frequencies are in an orthogonal relationship to each other and electric power corresponding to each subcarrier. The receiving circuit includes a demodulation/error correction circuit 20 that demodulates each subcarrier of the frequency-domain received signal DF1 and performs de-interleaving, error correction, and the like. The demodulation/error correction circuit 20 outputs transmitted bit strings. The demodulation/error correction circuit 20 estimates a bit error rate BER of a transmission path based on a number of bits whose errors have been corrected.

The receiving circuit includes a filter control circuit 10 that controls attenuation characteristics of the band-elimination filter BEF. The attenuation characteristics of the band-elimination filter BEF may be characteristics of attenuation in relation to the frequency. By controlling the attenuation characteristics, interference waves within the bandwidth of the desired signal may be removed or attenuated.

The filter control circuit 10 includes an interference wave measuring circuit 12 that measures frequency characteristics of an interference wave included in the frequency-domain received signal DF1, for example, the electric power of each subcarrier frequency, and a coefficient calculation circuit 14 that calculates coefficients 16 for controlling the band-elimination filter BEF so that the band-elimination filter BEF obtains the attenuation characteristics that have the opposite shape of the measured frequency characteristics of the interference wave. The band-elimination filter BEF may be a finite impulse response (FIR) filter having a number of taps of n+1. The attenuation characteristics of the FIR filter in relation to the frequency are changed in accordance with the control of coefficients C₀ to Cₙ corresponding to the number of taps n+1.

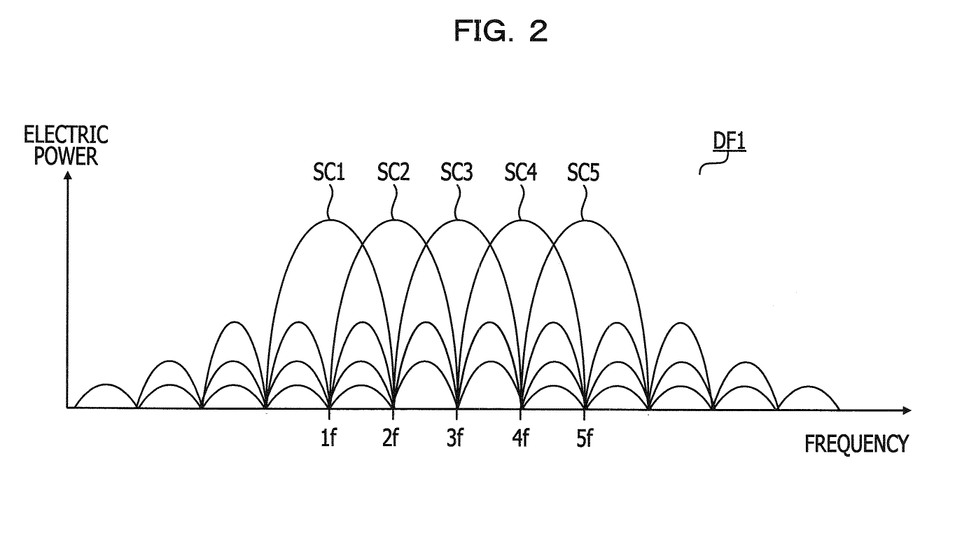

FIG. 2 illustrates an exemplary frequency spectrum. The frequency spectrum (frequency characteristics) illustrated in FIG. 2 may be the frequency spectrum of the frequency-domain received signal DF1. The abscissa represents the frequency, and the ordinate represents the signal strength, for example, the electric power. The fast Fourier transformer FFT performs a fast Fourier transform to convert the time-domain received signal DT2 in the OFDM to the frequency-domain received signal DF1. The frequency-domain received signal DF1 illustrated in FIG. 2 may, for example, include five subcarriers SC1 to SC5. The subcarriers SC1 to SC5 may have center frequencies 1f, 2f, 3f, 4f, and 5f, respectively. Because the electric power of respective adjacent subcarriers in the center frequencies 1f to 5f corresponds to a null point, interference between the subcarriers may be almost zero.

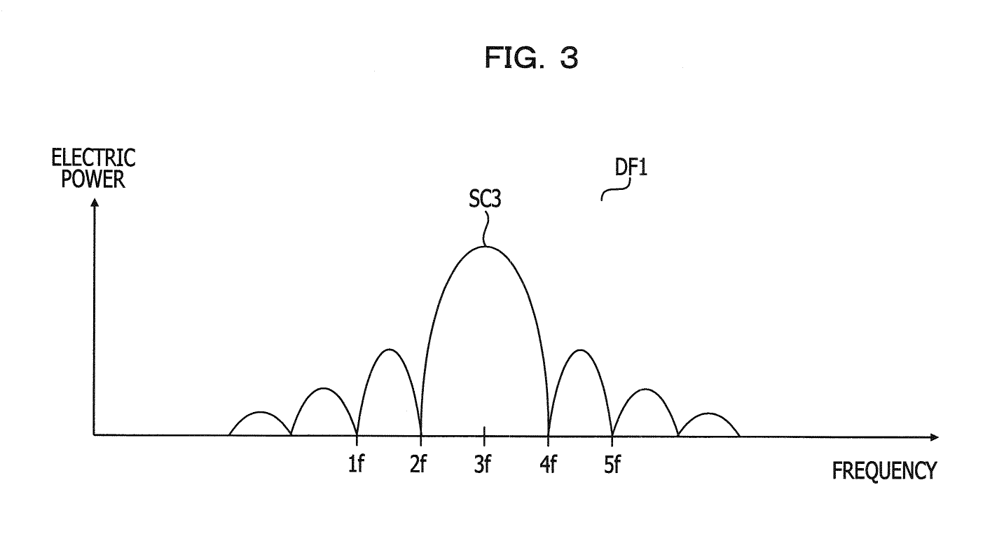

FIG. 3 illustrates an exemplary frequency spectrum. The frequency spectrum (frequency characteristics) illustrated in FIG. 3 may be the frequency spectrum of the frequency-domain received signal DF1. The abscissa represents the frequency, and the ordinate represents the signal strength, for example, the electric power. FIG. 3 illustrates the frequency spectrum of the single subcarrier SC3. There is a main lobe having the largest electric power around the center frequency 3f, along with side lobes having low electric power in frequency bands on both sides of the main lobe. The fast Fourier transformer FFT may be a discrete Fourier transformer. Since the time-domain received signal DT2 having a finite period of time is subjected to a fast Fourier transform, the frequency spectrum of the frequency-domain received signal DF1 which has been fast-Fourier-transformed, includes the main lobe thin the bandwidth of the subcarrier SC3 and the side lobes extending outside the bandwidth of the subcarrier SC3. The frequency spectrum may be a sin c function.

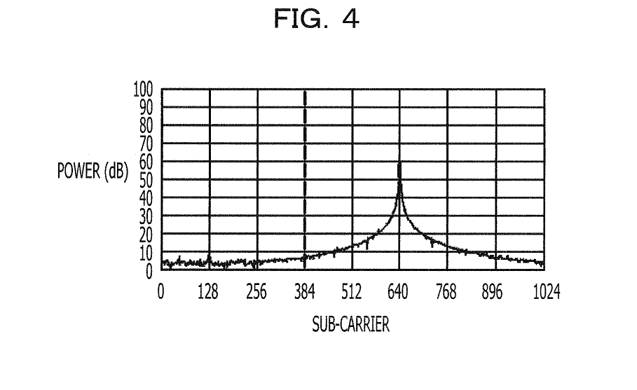

FIG. 4 illustrates an exemplary frequency spectrum. The frequency spectrum (frequency characteristics) illustrated in FIG. 4 may be a frequency spectrum when an unmodulated interference wave is fast-Fourier-transformed. The abscissa represents the frequency, for example, the subcarrier numbers, and the ordinate represents the electric power. The unmodulated interference wave may have a particular frequency, for example, the center frequency of a subcarrier SC640, and may not have, for example, the bandwidth illustrated in FIG. 3. When the unmodulated interference wave is fast-Fourier-transformed by the fast Fourier transformer FFT, the fast-Fourier-transformed unmodulated interference wave extends over a wide range of frequencies from the particular frequency as illustrated in FIG. 4. The extension over a wide range of frequencies from the particular frequency may correspond to the side lobes formed in the single subcarrier SC3 illustrated in FIG. 3.

When a frequency-domain signal which is obtained by fast-Fourier-transforming the interference wave illustrated in FIG. 4 is added, for example, to the frequency-domain received signal DF1 having the plurality of subcarriers illustrated in FIG. 2, the interference wave may overlap the center frequency of each subcarrier illustrated in FIG. 2, and the center frequency of each subcarrier corresponds to null points of adjacent subcarriers, resulting in destruction of the orthogonal relationship. The subcarriers overlapped by the interference wave may not be demodulated normally.

An interference wave may be removed from or attenuated in the time-domain received signal DT2 before a fast Fourier transform. When an interference wave exists within the bandwidth of a desired signal, the interference wave exists within a narrow frequency band in the time-domain received signal DT2. Therefore, even if a received signal within the bandwidth of the interference wave is removed or attenuated and errors occur in some subcarriers of the desired signal, the errors may be corrected through de-interleaving or error correction performed by the demodulation/error correction circuit 20.

In the frequency-domain received signal DF1 after the fast Fourier transform, since the electric power of an interference wave extends over a wide frequency band as illustrated in FIG. 4, errors may occur in many subcarriers and therefore error correction may not be performed.

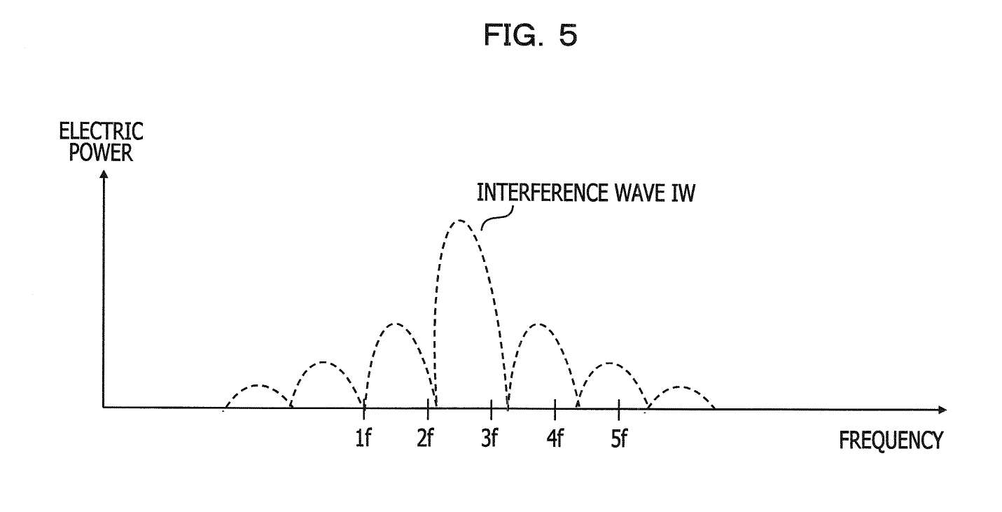

FIG. 5 illustrates an exemplary frequency spectrum. The frequency spectrum illustrated in FIG. 5 may be a frequency spectrum after a modulated interference wave IW is fast-Fourier-transformed. A main lobe of the interference wave IW, for example, the bandwidth of the interference wave IW, is formed over a frequency band from 2f to 3f. Side lobes are formed in wide ranges on both sides of the bandwidth of the interference wave IW as in FIG. 3. The frequency characteristics of the interference wave IW may not have a symmetrical shape.

When signals for digital broadcasting and signals for analog broadcasting are both in use, a signal for analog broadcasting may exist within the bandwidth of a signal for digital broadcasting corresponding to a desired signal, as an interference wave. A distorted interference wave such as that illustrated in FIG. 5 may occur. An interference wave generated by a wireless communication apparatus itself may exist within the bandwidth of the desired signal.

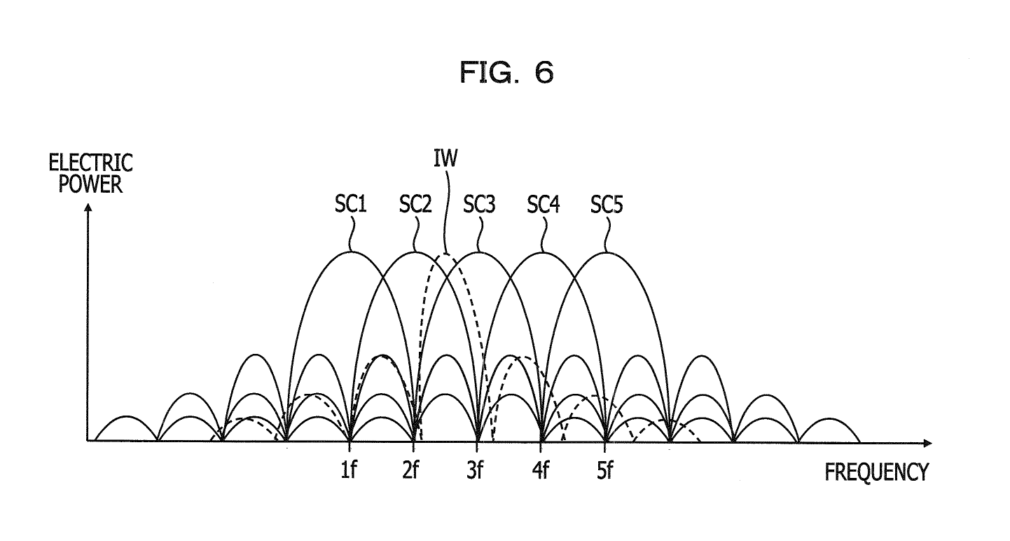

FIG. 6 illustrates an exemplary frequency spectrum. The frequency spectrum illustrated in FIG. 6 may be a frequency spectrum in which the frequency spectrum of the interference wave IW illustrated in FIG. 5 is superimposed on the frequency spectrum of the OFDM frequency-domain received signal DF1 illustrated in FIG. 2. In the frequency-domain received signal DF1 after the fast Fourier transform illustrated in FIG. 2, since the center frequency of each of the subcarriers SC1 to SC5 corresponds to null points of respective adjacent subcarriers, the subcarriers may not be affected. When the interference wave IW illustrated in FIG. 5 is superimposed on the frequency-domain received signal DF1, the spectrum of the interference wave IW that extends over a wide frequency band is superimposed on the center frequencies of many subcarriers as illustrated in FIG. 6, whereby the subcarriers, for example, the orthogonality between the subcarriers being affected. Therefore, errors in the subcarriers may not be corrected.

An interference wave that exists within the bandwidth of a desired signal may be removed from or attenuated in an analog or a digital signal before a fast Fourier transform.

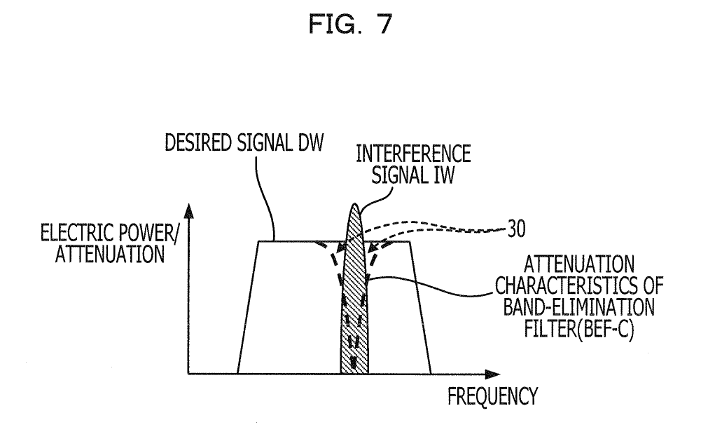

FIG. 7 illustrates exemplary frequency characteristics and exemplary attenuation characteristics. The frequency characteristics illustrated in FIG. 7 may be frequency characteristics of an interference wave, and the attenuation characteristics illustrated in FIG. 7 may be attenuation characteristics of the band-elimination filter BEF. Since the band-elimination filter BEF that removes or attenuates an interference wave is provided before a fast Fourier transform, the effect on the orthogonality between subcarriers is reduced, which may enable an appropriate demodulation of a desired signal. Since the desired signal may be attenuated appropriately, the attenuation characteristics of the band-elimination filter BEF may correspond to the frequency characteristics (frequency spectrum) of the interference wave.

FIG. 7 illustrates exemplary frequency characteristics. The abscissa illustrated in FIG. 7 represents the frequency, and the ordinate illustrated in FIG. 7 represents the electric power and the attenuation amount. The frequency characteristics illustrated in FIG. 7 may be frequency characteristics of a desired signal DW and frequency characteristics of an interference wave IW. The frequency characteristics of the interference wave IW may have, for example, a symmetrical shape. When the band-elimination filter BEF includes, for example, an LC circuit, the attenuation characteristics BEF-C have a symmetrical shape with a particular frequency as the center thereof as illustrated in FIG. 7, and therefore may not correspond to the shape of the frequency characteristics of the interference wave IW. In portions 30 illustrated in FIG. 7, frequency bands of the desired signal DW that are not affected by the interference wave IW may be removed or attenuated by the band-elimination filter BEF.

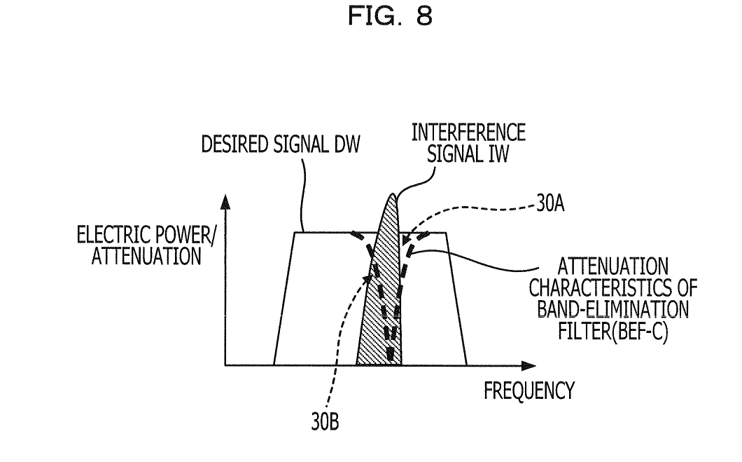

FIG. 8 illustrates an exemplary frequency characteristics and an example of the attenuation characteristics. The frequency characteristics illustrated in FIG. 8 may be frequency characteristics of an interference wave IW and the attenuation characteristics illustrated in FIG. 8 may be attenuation characteristics of the band-elimination filter BEF. The frequency characteristics of the interference wave IW may not have, for example, a symmetrical shape. The attenuation characteristics BEF-C of the band-elimination filter BEF have a symmetrical shape as in FIG. 7. In a portion 30A, the attenuation amount BEF-C of the band-elimination filter BEF is larger than the electric power of the interference wave IW, which may cause the desired signal DW to be attenuated. In a portion 30B, the attenuation amount BEF-C of the band-elimination filter BEF is smaller than the electric power of the interference wave IW, which may result in insufficient attenuation of the interference wave IW.

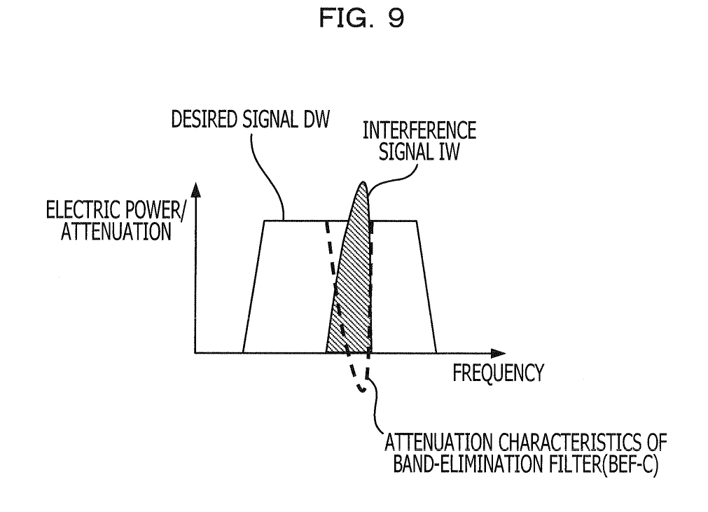

FIG. 9 illustrates exemplary frequency characteristics and exemplary attenuation characteristics. The frequency characteristics illustrated in FIG. 9 may be frequency characteristics of an interference wave IW, and the attenuation characteristics illustrated in FIG. 9 may be attenuation characteristics of the band-elimination filter BEF. The frequency characteristics of the interference wave IW may not have, for example, a symmetrical shape as in FIG. 8. For example, as illustrated in FIG. 9, the attenuation characteristics BEF-C of the band-elimination filter BEF may be controlled so that the shape of the attenuation characteristics BEF-C is opposite to that of the frequency characteristics of the interference wave IW. As illustrated in FIG. 9, the attenuation characteristics BEF-C of the band-elimination filter BEF have a shape obtained by turning upside down the frequency characteristics of the interference wave IW. Therefore, the electric power of the interference wave IW that exists within the bandwidth of a desired signal DW may be removed, thereby reducing the effect of the interference wave IW on the desired signal DW.

As illustrated in FIG. 1, in the receiving circuit, the filter control circuit 10 measures the frequency characteristics of an interference wave IW included in the frequency-domain received signal DF1, and controls the attenuation characteristics BEF-C of the band-elimination filter BEF so that the shape of the attenuation characteristics BEF-C is opposite to that of the measured frequency characteristics of the interference wave IW. The filter control circuit 10 includes the interference wave measuring circuit 12 that measures the frequency characteristics of an interference wave and the coefficient calculation circuit 14 that calculates coefficients for generating the attenuation characteristics that have the opposite shape of the measured frequency characteristics.

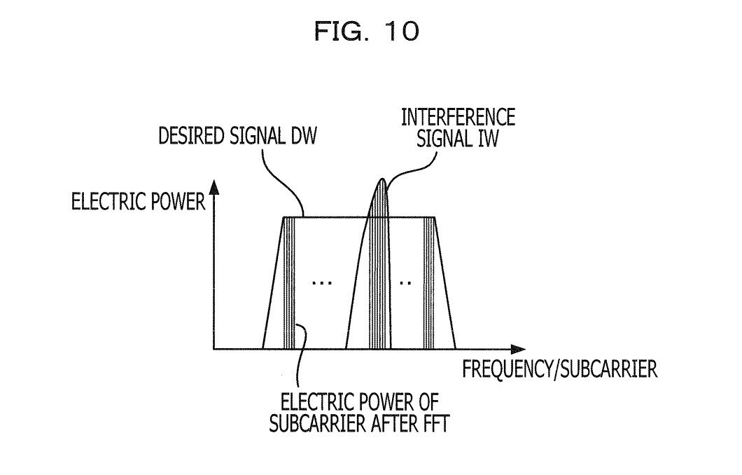

FIG. 10 illustrates an exemplary frequency spectrum. The frequency spectrum illustrated in FIG. 10 may be the frequency spectrum of the frequency-domain received signal DF1 after the fast Fourier transform. The abscissa represents the frequency or the subcarrier numbers, and the ordinate represents the electric power. Through a fast Fourier transform performed by the fast Fourier transformer FFT, the frequency-domain received signal DF1 including signals for each of the bandwidths of a plurality of subcarriers is generated. Since an interference wave IW exists within the bandwidth of a desired signal DW, the frequency characteristics (frequency spectrum) of the interference wave IW may be measured by the following two methods.

In the first method, the frequency characteristics of the frequency-domain received signal DF1 are measured in a non-transmission period that exists between a transmission period and a reception period of Worldwide Interoperability for Microwave Access (WiMax) or the like. Because there is no desired signal DW in the non-transmission period, the frequency characteristics of the frequency-domain received signal DF1 may be the frequency characteristics of the interference wave IW. For example, the electric power of each subcarrier frequency of the frequency-domain received signal DF1 is calculated. The electric power at each receiving point may be calculated.

In the second method, when the non-transmission period does not exist, a displacement power from an ideal point at frequency of a known signal, for example, at frequency of a pilot subcarrier to a receiving point is calculated. Because a vector of the ideal point is a known signal, the electric power of a displacement vector, which is a difference between the vector of the receiving point and the vector of the ideal point, may be calculated.

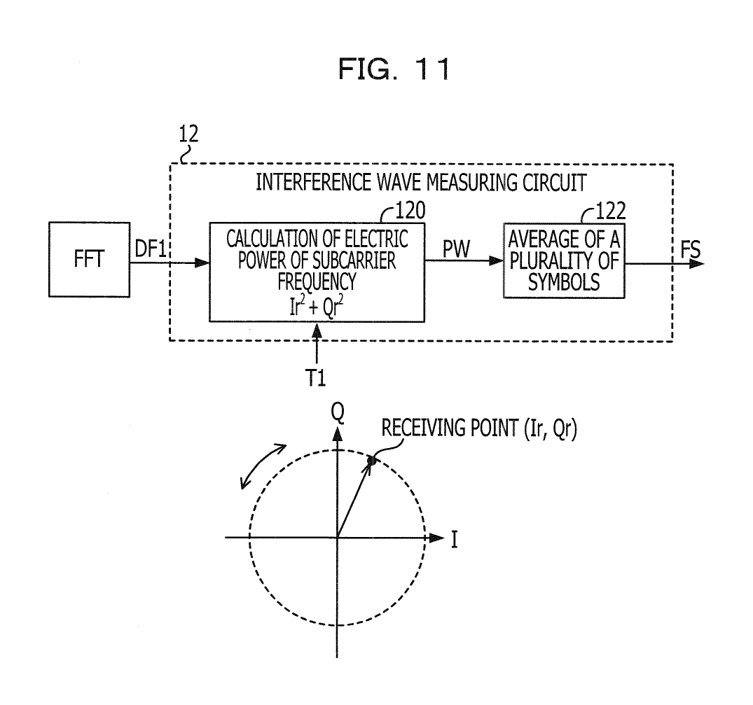

FIG. 11 illustrates an exemplary interference wave measuring circuit. The interference wave measuring circuit illustrated in FIG. 11 may be applied to a wireless communication method having a non-transmission period. The interference wave measuring circuit 12 has an electric power calculation circuit 120 that calculates the electric power of each subcarrier frequency of the frequency-domain received signal DF1 after the fast Fourier transform in response to a non-transmission period signal Ti indicating a non-transmission period, and an averaging circuit 122 that outputs a frequency spectrum FS of an interference wave by averaging the values of the electric power PW, which are output from the electric power calculation circuit 120, at a plurality of symbols. The frequency spectrum FS may correspond to the frequency spectrum of the interference wave.

The non-transmission period signal Ti may be supplied from a superior control circuit (not illustrated). During the non-transmission period, because the interference wave IW illustrated in FIG. 10 from which the desired signal DW has been removed is included in the frequency-domain received signal DF1, a receiving point of the interference wave in I-Q coordinates revolves around the origin as illustrated in FIG. 11 in accordance with the deviation between a subcarrier frequency and the frequency of the interference wave IW. The electric power calculation circuit 120 calculates the electric power PW=Ir²+Qr² at the receiving point (Ir, Qr) for each subcarrier frequency. The receiving point (Ir, Qr) used for the calculation may be supplied from, for example, the demodulation/error correction circuit 20.

The averaging circuit 122 may average a number corresponding to a plurality of symbol periods in the non-transmission period or the electric power PW for each subcarrier frequency in order to output an accurate frequency spectrum FS of the interference wave IW.

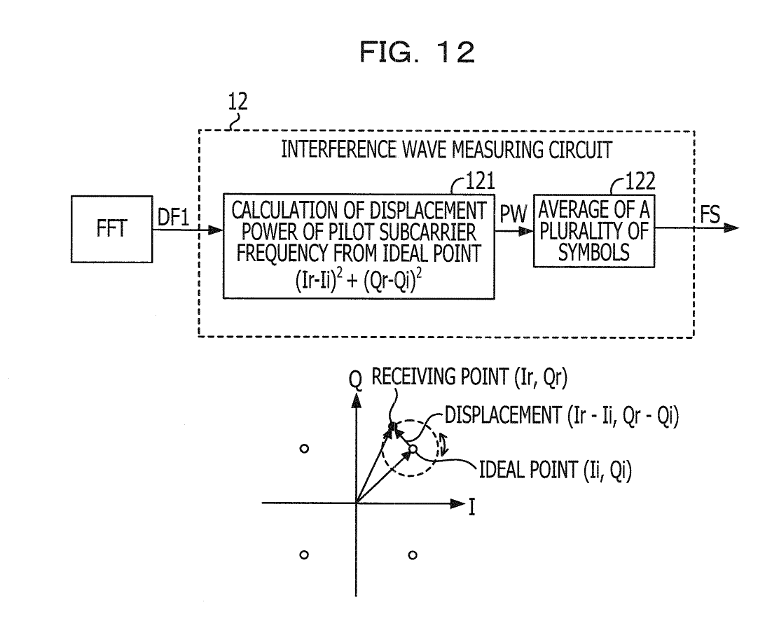

FIG. 12 illustrates an exemplary interference wave measuring circuit. The interference wave measuring circuit 12 illustrated in FIG. 12 may be applied to a wireless communication method having no non-transmission period. Since there is no non-transmission period, the desired signal DW and the interference wave IW both exist as illustrated in FIG. 10. Because a known signal, for example, a pilot subcarrier, is included in the desired signal DW, the electric power PW of the interference wave IW may be calculated.

Pilot subcarriers are included in a plurality of subcarriers in an OFDM symbol and a pilot subcarrier includes a pilot signal and an interference wave. Therefore, as illustrated in FIG. 12, the receiving point (Ir, Qr) revolves around the ideal point (Ii, Qi) of the pilot signal with a radius corresponding to the electric power of the interference wave. The deviation between a pilot subcarrier frequency and the frequency of the interference wave causes the revolution.

The electric power calculation circuit 121 calculates the electric power PW=(Ir−Ii)²+(Qr−Qi)² of a displacement vector (Ir−Ii, Qr−Qi) from an ideal point (Ii, Qi) of the known pilot signal to a receiving point (Ir, Qr) for a pilot subcarrier frequency. The interference wave measuring circuit 12 includes an electric power calculation circuit 121 that calculates the electric power of each pilot subcarrier frequency of the frequency-domain received signal DF1 after the fast Fourier transform and the averaging circuit 122 that outputs a frequency spectrum FS of an interference wave by averaging the values of the electric power PW, which are output from the electric power calculation circuit 121, at a plurality of symbols. The averaging circuit 122 may obtain the frequency spectrum FS of the interference wave by interpolating the electric power of frequencies between pilot subcarriers.

The interference wave measuring circuit 12 illustrated in FIG. 11 or 12 generates a frequency spectrum of the interference wave IW illustrated in FIG. 10, for example, a characteristics curve of the electric power in relation to the frequency. The coefficient calculation circuit 14 illustrated in FIG. 1 calculates the coefficients 16 of the FIR filter corresponding to the band-elimination filter BEF based on the frequency spectrum FS.

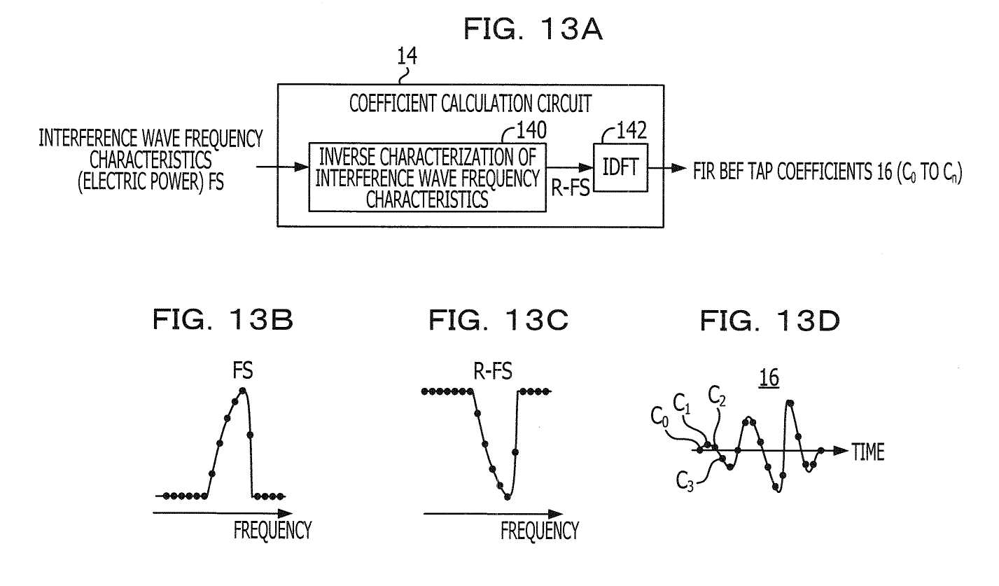

FIG. 13A illustrates an exemplary coefficient calculation circuit. FIGS. 13B to 13D illustrate an exemplary frequency spectrum. FIG. 13B illustrates the frequency spectrum (frequency characteristics) FS of an interference wave generated by the interference wave measuring circuit 12. The frequency spectrum FS may correspond to the electric power of an interference wave whose subcarrier frequencies correspond to the sampling points. An inverse characterization circuit 140 in the coefficient calculation circuit 14 inversely characterizes the shape of the electric power of the frequency spectrum FS. For example, the values of the electric power of the frequency spectrum FS may be subtracted from a certain standard value. Inverse characteristics R-FS may have the shape obtained by turning upside down the frequency spectrum FS as illustrated in FIG. 13C. The inverse characteristics R-FS may be a frequency-domain signal.

An inverse discrete Fourier transformer IDFT 142 in the coefficient calculation circuit 14 inverse-discrete-Fourier-transforms the inverse characteristics R-FS to a time-domain signal. The inverse-discrete-Fourier-transformed time-domain signal may be a signal along a time axis as illustrated in FIG. 13D, and the electric power C₀ to Cₙ at discrete points may correspond to the coefficients 16 of the FIR filter.

The FIR filter including the band-elimination filter BEF illustrated in FIG. 1 may remove or attenuate the electric power of an interference wave included in the time-domain received signal DT1 by multiplying the analog-to-digital-converted time-domain received signal DT1 by the time-domain signal illustrated in FIG. 13D. The time-domain received signal DT1 includes, for example, a time-domain signal illustrated in FIG. 13A that is obtained by inverse-discrete-Fourier-transforming the frequency-domain signal FS of the interference wave. Therefore, by multiplying the time-domain received signal DT1 by the coefficients C₀ to Cₙ corresponding to the time-domain signal obtained by inverse-discrete-Fourier-transforming the inverse characteristics R-FS, the electric power of the interference wave may be removed or attenuated.

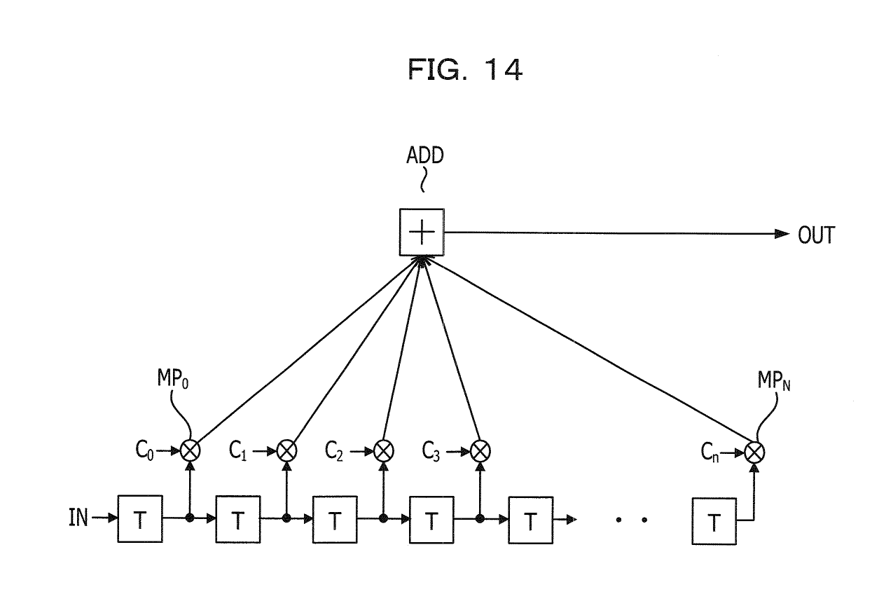

FIG. 14 illustrates an exemplary band-elimination filter BEF. The band-elimination filter BEF may include the FIR filter, and includes n+1 delay circuits Ts, multipliers MP₀ to MPₙ that multiply the outputs of the delay circuits Ts and the respective coefficients C₀ to Cₙ together, and an adder ADD that accumulates the results of the multiplication. The delay amount of each delay circuit T may correspond to the time period between the sampling points of the corresponding coefficients illustrated in FIG. 13C. For example, the FIR filter may remove or attenuate the electric power of the interference wave based on the inverse characteristics R-FS by multiplying the values of the electric power of the sampling points of the time-domain signal.

In the filter control circuit 10 illustrated in FIG. 1, the coefficient calculation circuit 14 obtains the coefficients of the inverse characteristics of the frequency characteristics of an interference wave based on the frequency characteristics of the interference wave measured by the interference wave measuring circuit 12 for a certain period of time. An integrator disposed in the coefficient calculation circuit 14 may integrate the coefficients to converge the electric power of the interference wave to zero in the frequency-domain received signal DF1.

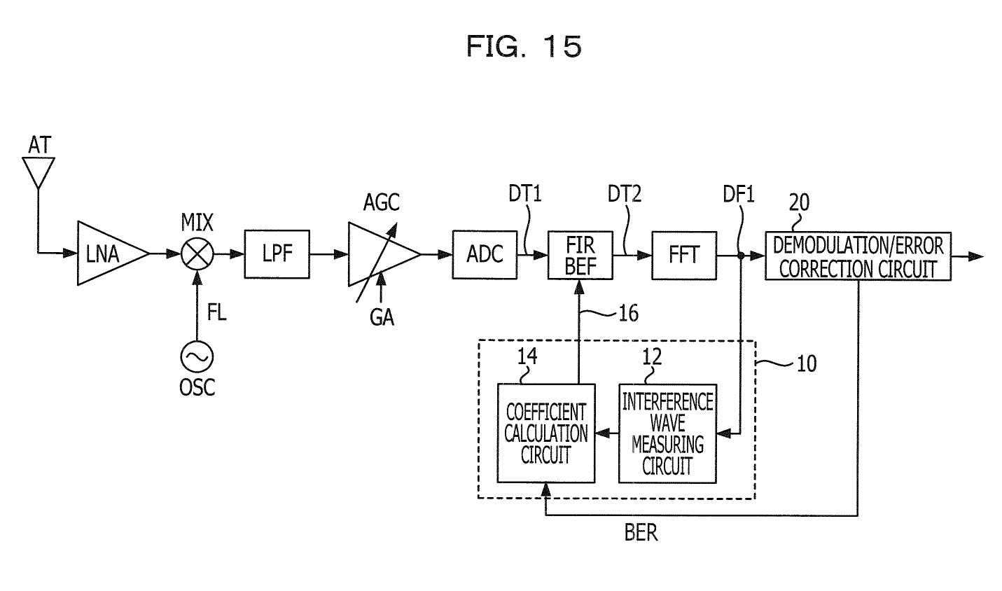

FIG. 15 illustrates an exemplary receiving circuit. The configuration of the receiving circuit may be the same as or similar to that illustrated in FIG. 1. In FIG. 15, elements similar to or the same as those in FIG. 1 are given the same numerals. The bit error rate BER is supplied from the demodulation/error correction circuit 20 to the filter control circuit 10.

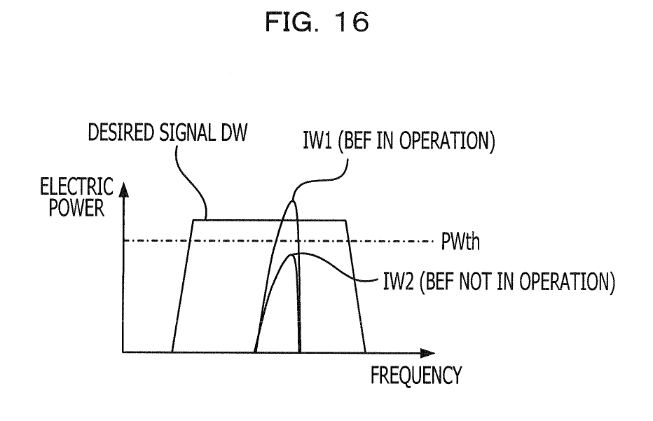

FIG. 16 illustrates an exemplary frequency spectrum. FIG. 16 illustrates the frequency spectrum of a received signal. An interference wave IW1 having a peak power higher than a power threshold PWth for an average power of a desired signal DW and an interference wave IW2 having a peak power lower than the power threshold PWth are illustrated.

When the peak power of a measured interference wave IW is higher than the power threshold PWth, the coefficients C₀ to Cₙ calculated by the coefficient calculation circuit 14 are set for the FIR filter in the band-elimination filter BEF, and thereby the interference wave IW may be removed or attenuated. When the peak power of a measured interference wave IW is lower than the power threshold PWth, the interference wave removal or attenuation function of the band-elimination filter BEF may be reduced or may not be performed. The interference wave removal or attenuation function may not be performed because, instead of the coefficients C₀ to Cₙ calculated by the coefficient calculation circuit 14 being set, a center coefficient (Cₙ+1)/2 is set as 1 and the other coefficients as 0, which makes the FIR filter operate as a filter having an amount of delay of T(n+1)/2.

When the peak power of an interference wave IW is lower than the power threshold PWth, errors may be corrected by the demodulation/error correction circuit 20 because the degree of destruction of the orthogonal relationship in the frequency-domain received signal DF1 after the fast Fourier transform is small.

The demodulation/error correction circuit 20 monitors the measured bit error rate BER so as to optimize the power threshold PWth. The power threshold PWth, which determines whether or not to operate the band-elimination filter BEF, may be set so as to, for example, minimize the bit error rate BER. When the power threshold PWth is set high, the frequency of interference wave removal or attenuation by the band-elimination filter BEF may be lowered. When the power threshold PWth is set low, the frequency may be increased. Since the bit error rate BER varies depending on the power threshold PWth, the power threshold PWth may be set so as to minimize the bit error rate BER. The power threshold PWth is controlled based on the coefficient calculation circuit 14.

The power threshold PWth may be set first after the receiving circuit is arranged, and the power threshold PWth set as the initial value may be used continuously. The power threshold PWth may be set regularly, instead. For example, setting may be performed upon a power-on of the application or at certain intervals.

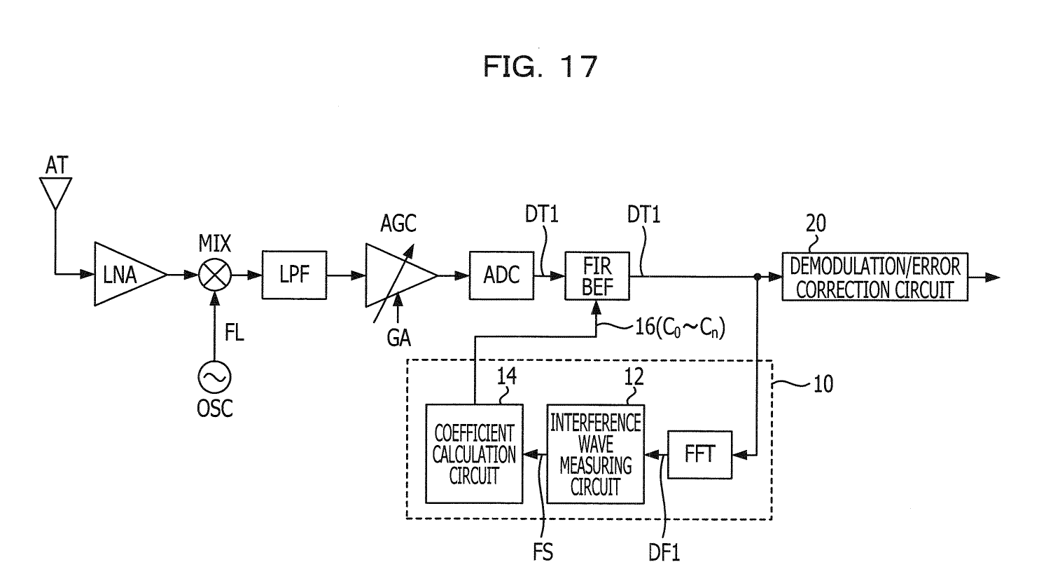

FIG. 17 illustrates an exemplary receiving circuit. In the wireless communication illustrated in FIG. 17, a transmission signal may be a signal along a time axis, instead of being a frequency-domain signal transmitted through air as in the OFDM and OFDMA. Therefore, the fast Fourier transformer FFT may not be provided upstream of the demodulation/error correction circuit 20.

The fast Fourier transformer FFT may be provided in the filter control circuit 10. The interference wave measuring circuit 12 measures the electric power of an interference wave for each sample frequency based on the frequency-domain received signal DF1 after the fast Fourier transform and generates the frequency characteristics FS of the interference wave. Similar to FIGS. 1 and 15, the coefficient calculation circuit 14 may calculate the coefficients 16 based on the frequency characteristics FS of the interference wave and set the tap coefficients of the FIR filter in the band-elimination filter BEF.

Example embodiments of the present invention have now been described in accordance with the above advantages. It will be appreciated that these examples are merely illustrative of the invention. Many variations and modifications will be apparent to those skilled in the art.

1. A receiving circuit comprising:
an analog-to-digital converter to convert an input signal in a certain bandwidth to a digital signal;
a Fourier transformer to convert the digital signal from a time-domain signal to a frequency-domain signal;
a band-elimination filter to extract an interference wave signal from the time-domain signal; and
a filter control circuit to measure frequency characteristics of the interference wave signal so that the attenuation characteristics of the band-elimination filter has a attenuation characteristics opposite to the frequency characteristics in a direction.

2. The receiving circuit according to claim 1, wherein the input signal includes one of an orthogonal frequency-division multiplexing signal communication and an orthogonal frequency-division multiplexing access signal.

3. The receiving circuit according to claim 1, wherein the band-elimination filter includes:
a plurality of delay circuits to delay the time-domain signal;
a plurality of multiplier circuits to multiply a respective output of the plurality of delay circuits by coefficients; and
an adder circuit to accumulate outputs of the plurality of multiplier circuits,
wherein the filter control circuit supplies the band-elimination filter with coefficients corresponding to the attenuation characteristics opposite to the frequency characteristics.

4. The receiving circuit according to claim 1, wherein the frequency characteristics correspond to an interference wave frequency-domain signal having an electric power for a frequency at a sampling point of the frequency-domain signal,
wherein the filter control circuit includes:
an inverse characteristics generating circuit to generate an inverse interference wave frequency-domain signal having an electric power opposite to the electric power of the interference wave frequency-domain signal in a direction; and
an inverse discrete Fourier transformer to convert the inverse interference wave frequency-domain signal to an inverse interference wave time-domain signal, and
wherein the filter control circuit supplies the band-elimination filter with an electric power at a sampling point of the inverse interference wave time-domain signal as a coefficient.

5. The receiving circuit according to claim 1, wherein the filter control circuit calculates electric power of a subcarrier frequency of the frequency-domain signal in a non-transmission period to obtain the frequency characteristics.

6. The receiving circuit according to claim 1, wherein the filter control circuit calculates a displacement power of a signal included in the frequency-domain signal in a transmission period from an ideal point to a receiving point at a subcarrier frequency corresponding to the signal to obtain the frequency characteristics.

7. The receiving circuit according to claim 1, wherein the filter control circuit stops at least one function of the band-elimination filter when a peak power of the frequency characteristics does not exceed a standard value, and
wherein the filter control circuit operates at least one of the functions of the band-elimination filter when the peak power of the frequency characteristics exceeds the standard value.

8. The receiving circuit according to claim 7, wherein the filter control circuit sets the standard value so that a bit error rate of a bit signal extracted from the frequency-domain signal is reduced.

9. The receiving circuit according to claim 1, wherein the filter control circuit sets the standard value periodically.

10. The receiving circuit according to claim 1, wherein the band-elimination filter includes a finite impulse response filter.

11. A receiving circuit comprising:
an analog-to-digital converter to convert an input signal in a certain bandwidth to a digital received signal;
a band-elimination filter to extract an interference wave signal from the digital signal; and
a filter control circuit to measure frequency characteristics of the interference wave signal so that the attenuation characteristics of the band-elimination filter has attenuation characteristics opposite to the frequency characteristics in a direction.

12. The receiving circuit according to claim 11, wherein the band-elimination filter includes:
a plurality of delay circuits to delay the digital received signal;
a plurality of multiplier circuits to multiply respective outputs of the plurality of delay circuits by coefficients; and
an adder circuit configured to add outputs of the plurality of multiplier circuits,
wherein the filter control circuit supplies the band-elimination filter with coefficients corresponding to the attenuation characteristics opposite to the frequency characteristics in the direction.
